(19) United States
(12) Patent Application Publication
(10) Pub. No.: US 2004/0143614 A1
(43) Pub. Date: Jul. 22, 2004

(54) Hiding the internal state of a random number generator

(76) Inventor: Leonard D. Rarick, San Diego, CA (US)

Correspondence Address: B. Noel Kivlin, Meyertons, Hood, Kivlin, Kowert & Goetzel, P.C., P.O. Box 398, Austin, TX, 78767, US

(21) Appl. No.: 10/347,755

(22) Filed: Jan. 21, 2003

(51) Int. Cl. G06F 1/02

(52) U.S. Cl. 708/250

(57) ABSTRACT

A method and system for obscuring the internal state of a random number generator. The method includes a random number generator generating a first plurality of bits, wherein the first plurality of bits includes at least one data bit and at least one protection bit. A logic function (e.g. an exclusive OR) function may be performed on the first plurality of bits. Performing the logic function on the first plurality of bits may generate a second plurality of bits, which may then be output by the random number generator. The internal state of the random number generator may be obscured by using the logic function to generate the second plurality (i.e. output) of bits from the first plurality of bits.

### BACKGROUND OF THE INVENTION

1. Field of the Invention

This invention relates in general to electronics and computer systems, and more particularly to random number generators used in such systems.

2. Description of the Related Art

The use of random numbers, both as true random numbers (TRN) and pseudorandom numbers (PRN), is very important in many modern technologies. The advent of the personal computer, server computers, computer networks, and the internet have led to an increase in the interest in computer security, which is one area where random numbers may be used. U.S. National Institute of Standards and Technology (NIST) cryptographic standards are specified in the Federal Information Processing Standards (FIPS). Tests for randomness are given in the NIST Special Publication 800-22 (with revisions dated May 15, 2001, entitled “A Statistical Test Suite For Random and Pseudorandom Number Generators For Cryptographic Applications.”

Since random numbers are often used in cryptographic and other security sensitive applications, it is important that the output of a random number generator not reveal any of its internal state variables. To this end a function known as a hash function may be applied to some of the internal variables in order to create the output. These hash functions may be used for a wide variety of applications, including message authentication and data security. Some hash functions may be suitable for software-based random number generators but may be too large and too slow for a hardware-based random number generator. Furthermore, hash functions may be required for other purposes, such as encrypting files or messages. For these applications, a hash function may be required that is both small and fast yet still able to effectively obscure the internal variables of the random number generator.

### SUMMARY OF THE INVENTION

A method and system for obscuring the internal state of a random number generator is disclosed. The method includes a random number generator generating a first plurality of bits, wherein the first plurality of bits includes at least one data bit and at least one protection bit. A logic function (e.g. an exclusive OR) function may be performed on the first plurality of bits. Performing the logic function on the first plurality of bits may generate a second plurality of bits, which may then be output by the random number generator.

### BRIEF DESCRIPTION OF THE DRAWINGS

Other aspects of the invention will become apparent upon reading the following detailed description and upon reference to the accompanying drawings in which:

FIG. 1 is a block diagram of one embodiment of a system utilizing a random number generator;

FIG. 2 is a block diagram of one embodiment of a random number generator including a logic unit for obscuring its internal state;

FIG. 3A is a diagram of one embodiment of a logic unit for obscuring the internal state of a random number generator;

FIG. 3B is a block diagram of an alternate embodiment of the logic unit illustrated in FIG. 3A;

FIG. 4 is a diagram of another embodiment of a logic unit for obscuring the internal state of a random number generator;

FIG. 5 is a diagram of another embodiment of a logic unit for obscuring the internal state of a random number generator;

FIG. 6 is a diagram of another embodiment of a logic unit for obscuring the internal state of a random number generator;

FIG. 7A is a diagram of another embodiment of a logic unit for obscuring the internal state of a random number generator;

FIG. 7B is a diagram of an alternate embodiment of the logic unit illustrated in FIG. 7A;

FIG. 8 is a diagram of another embodiment of a logic unit for obscuring the internal state of a random number generator;

FIG. 9 is a flow diagram for one embodiment of obscuring the internal state of a random number generator; and

FIG. 10 is a block diagram of a computer system including a carrier medium configured to store instructions for implementing a software-based random number generator with an obscuring function.

While the invention is susceptible to various modifications and alternative forms, specific embodiments thereof are shown by way of example in the drawings and will herein be described in detail. It should be understood, however, that the drawings and description thereto are not intended to limit the invention to the particular form disclosed, but, on the contrary, the invention is to cover all modifications, equivalents, and alternatives falling with the spirit and scope of the present invention as defined by the appended claims.

### DETAILED DESCRIPTION OF THE INVENTION

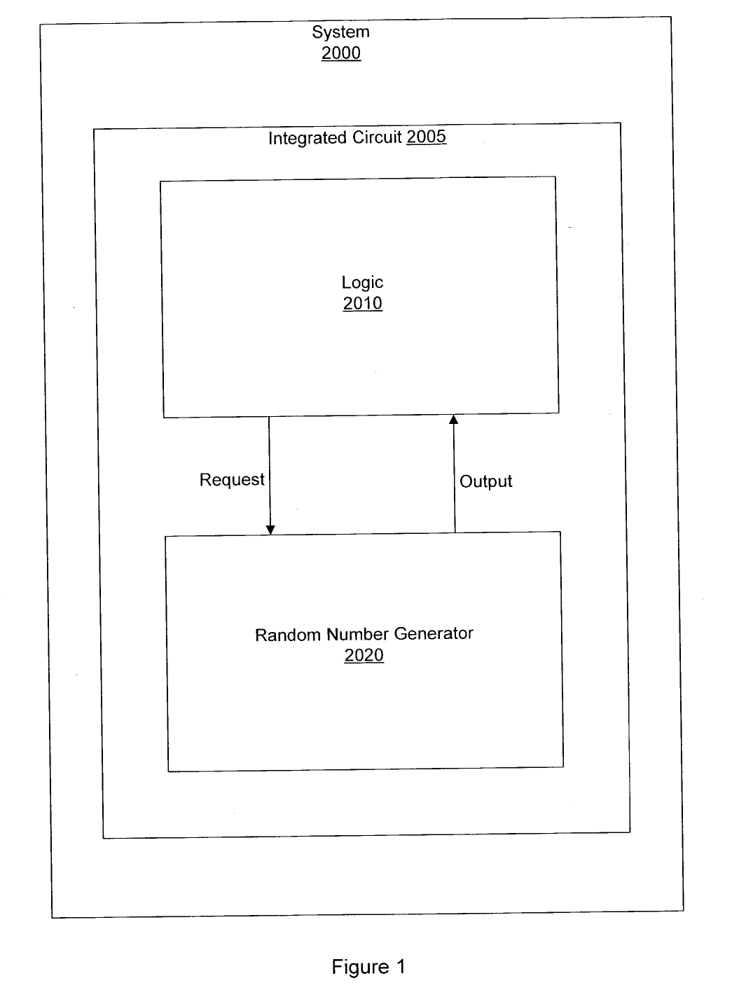

Turning now to FIG. 1, a block diagram of one embodiment of a system utilizing a random number generator is shown. In the embodiment shown, system 2000 includes an integrated circuit 2005. Integrated circuit 2005 includes logic 2010, which is coupled to random number generator 2020. Logic 2010 may include various processor logic, digital signal processing logic, a co-processor, or virtually any other type of logic where random numbers may be useful or required.

Random number generator 2020 may be one of several different types of random number generators. These types include continuous random number generators, pseudorandom number generators, Heisenberg random number generators, and so on. In one embodiment, random number generator 2020 may be configured to output a random number (as a plurality of randomly generated bits) synchronous to a clock cycle. A random number may be output once each clock cycle in some embodiments, while in other embodiments a random number may be output once each for a certain number of clock cycles (e.g. 1 random number output every 5 clock cycles). Embodiments are possible and contemplated wherein a random number is output more than once each clock cycle, such as in a system employing double data rate (DDR) techniques. Random number generator may also be configured to output a random number only after receiving a request signal from logic 2010.

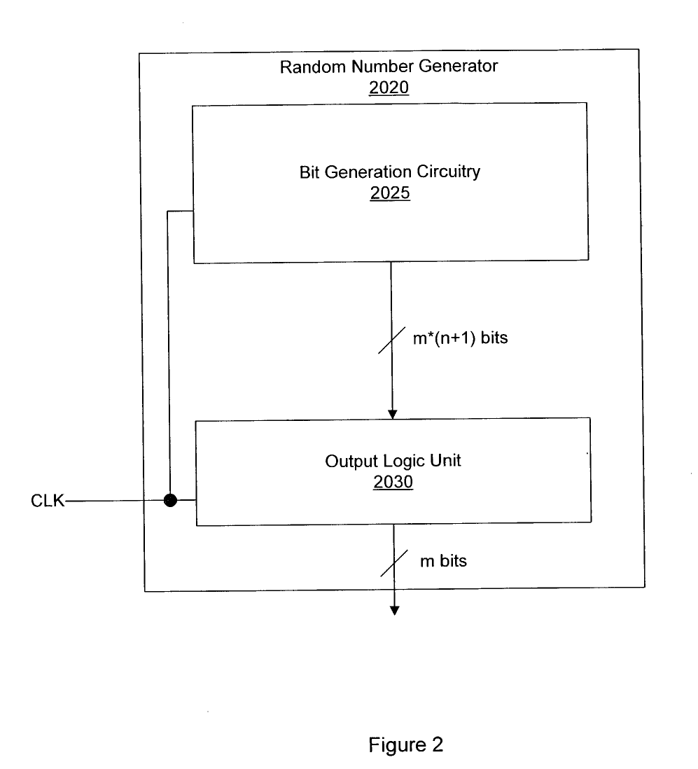

Moving now to FIG. 2, a block diagram of one embodiment of a random number generator including a logic unit for obscuring its internal state is shown. In the embodiment shown, random number generator 2020 includes bit generation circuit 2025 and output logic unit 2030. Bit generation circuitry 2025 may be configured to randomly generate a plurality of bits, and may use any type of random number generation algorithm available. The generated bits may be forwarded to output logic unit 2030. Output logic unit 2030 may perform an obscuring function designed to prevent the internal state of bit generation circuitry 2025 from being revealed.

In the embodiment shown, random number generator is configured to output a total of m bits, where m is an integer. However, bit generation circuitry 2025 is configured to generate a total of m*(n+1) bits, wherein n is a ratio of a number of protection bits to a number of data bits, and may by an integer or a non-integer value. In this particular embodiment, the number of data bits is m. Thus, bit generation circuitry 2025 is configured to randomly generate a plurality of bits that include a number of bits equal to the number of output data bits (m) as well as a number of protection bits.

The generation of the extra bits known as protection bits may aid in obscuring the internal state of the bit generation circuitry 2025 of random number generator 2020. This is due to the fact that a number of different combinations of inputs to the output logic unit (i.e. states of the bit generation circuitry) may produce the same combination of outputs. If the number of possible internal random number generator states to produce a given output state is large enough, it may become impractical to explore all of these input states. For example, if bit generation circuit 2025 providing 30 protection bits, then there are 2³⁰ combinations that may result in the final output of random number generator 2020. Similarly, if bit generation circuitry generates 60, 90, or 120 protection bits then either 2⁶⁰, 2⁹⁰, or 2¹²⁰ combinations of outputs exist (respectively) for the bit generation circuitry.

As previously noted, bit generation circuitry 2025 is configured to generate m*(n+1) bits, where m is the number of data bits output by the random generator and n is the ratio of the number of protection bits to the number of data bits. Thus, if the ratio n=1, then twice as many bits need to be generated than there are output bits—1 protection bit for each data bit output by random number generator 2020. If the ratio n=2, then 3 times as many bits need be generated as there are output bits—2 protection bits generated for each output data bit. As also noted, the ratio n need not be an integer. Table 1 below illustrates an embodiment wherein the ratio n=0.67, and wherein the number of data bits m=3 (and thus 3 protection bits are generated for every 2 data bits). Note that the table covers only a subset (half) of all the possible output conditions.

TABLE 1

| INPUTS | | | | | OUTPUTS | | |
|---|---|---|---|---|---|---|---|
| A | B | C | D | E | X | Y | Z |
| 0 | 0 | 0 | 0 | 0 | 0 | 0 | 0 |
| 0 | 1 | 1 | 0 | 1 | 0 | 0 | 0 |
| 1 | 0 | 1 | 1 | 0 | 0 | 0 | 0 |
| 1 | 1 | 0 | 1 | 1 | 0 | 0 | 0 |
| 0 | 0 | 0 | 0 | 1 | 0 | 0 | 1 |
| 0 | 1 | 1 | 0 | 0 | 0 | 0 | 1 |
| 1 | 0 | 1 | 1 | 1 | 0 | 0 | 1 |
| 1 | 1 | 0 | 1 | 0 | 0 | 0 | 1 |
| 0 | 0 | 0 | 1 | 0 | 0 | 1 | 0 |
| 0 | 1 | 1 | 1 | 1 | 0 | 1 | 0 |
| 1 | 0 | 1 | 0 | 0 | 0 | 1 | 0 |
| 1 | 1 | 0 | 0 | 1 | 0 | 1 | 0 |
| 0 | 0 | 0 | 1 | 1 | 0 | 1 | 1 |
| 0 | 1 | 1 | 1 | 0 | 0 | 1 | 1 |
| 1 | 0 | 1 | 0 | 1 | 0 | 1 | 1 |
| 1 | 1 | 0 | 0 | 0 | 0 | 1 | 1 |

Table 1 shown above illustrates how internal states may be obscured by generating protection bits in addition to the data bits. In the example shown in Table 1, 5 bits total may be randomly generated by bit generation circuitry 2025, while a total of 3 data bits are output from random number generator 2020 via output logic unit 2030. For example, a random number generator output of XYZ=000 may be generated by one of four different combinations of bits A, B, C, D, and E in this particular embodiment. The generated bits A, B, C, D, and E may be input into a logic unit such as output logic unit 2030. The individual bits of each input combination for a given output combination may be either a logic 1 or a logic 0, which adds further difficulty in determining the exact internal state of random number generator 2020 which produced a given output state.

Logic functions such as that which produces the combination of outputs shown in this particular example may be expanded for larger output words (e.g. 16 bits, 64 bits, etc). When the extra protection bits are considered, it can easily be seen how a logic function may obscure the internal state of random number generator 2025. For example, assume the random number generator provides 64 data bit outputs (m=64) and the bit generation circuitry generates one protection bit for each data bit generated (n=1). Thus, m*(n+1)=128 bits, and thus the number of possible combinations for the output bits is 2⁶⁴, and may be produced by 2¹²⁸ combinations that may be generated by bit generation circuitry 2025. As such, for any single combination of output bits may be produced by one of 2⁶⁴ bit combinations generated by bit generation circuitry 2025.

If random number generator 2020 is to provide 64 (m=64) output bits, with bit generation circuitry generating 2 protection bits (n=2) for each data bit, then a total of 192 bits may be generated by bit generation circuitry 2025. Therefore, bit generation circuitry may produce 2¹⁹² combinations of inputs to output logic unit 2030. Thus, there are 2⁶⁴ combinations of output bits from random number generator 2020, wherein each combination of output bits may be produced by one of 2¹²⁸ combinations of bits generated by bit generation circuitry 2025. Performing such a large number of computations in order to reveal the inner state of the random number generator for either of the two preceding examples may be beyond the reach of current technology. Performing a sufficient number of combinations to reveal the inner state for a random number generator producing a smaller number of data and protection bits (e.g. 32 output bits with 1 protection bit for each output bit for a total of 64 bits generated by the bit generation circuitry) may tax currently available technologies to their reasonable limits.

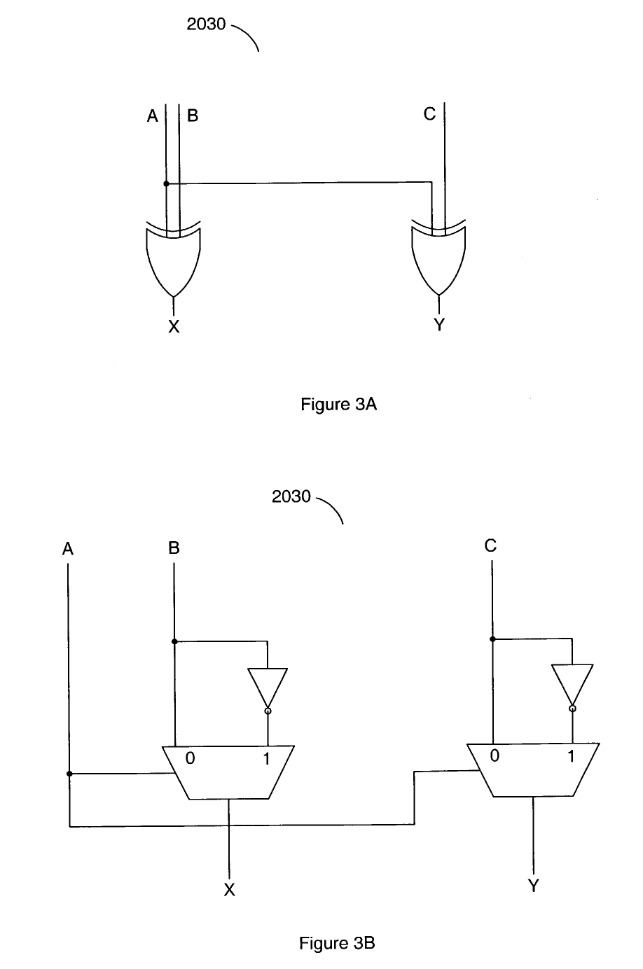

Moving now to FIG. 3A, a diagram of one embodiment of a logic unit for obscuring the internal state of a random number generator is shown. In the embodiment shown, output logic unit 2030 comprises two exclusive OR (XOR) gates. A software implementation of this embodiment may utilize the XOR function of a processor instruction set, or may create an XOR function based on more AND, OR, and inverter functions (it should also be noted that the XOR function in hardware may be implemented by combining AND, OR, and inverter functions). A total of 3 input bits (A, B, and C) provided by bit generation circuitry may be input into this embodiment of output logic unit 2030 and produce 2 output bits. Thus, in this particular embodiment, m=2 and n=0.5. This particular embodiment (as well as the other illustrated herein or otherwise contemplated) may be used as a basic building block in constructing larger implementations of output logic unit 2030. For example, the embodiment shown in FIG. 3A may be repeated 16 times thereby resulting in an output logic unit that produces 32 output bits based on 48 randomly generated bits received from bit generation circuitry.

FIG. 3B is a diagram of an alternate embodiment of the logic unit illustrated in FIG. 3A. The embodiment shown in FIG. 3B may perform a similar function to that of FIG. 3A, but may be implemented using a multiplexer function instead of an XOR function. As with FIG. 3A, the embodiment shown in FIG. 3B may be implemented either in hardware or software. In this particular example, two of the input bits may be provided to the multiplexers (one each to each multiplexer, with an inverter on one of the multiplexer inputs) while a third input bit may be provided to the select input of both multiplexers. Thus, the 3 input bit may produce 2 output bits, and thus m=2 while n=0.5. As with the embodiment of FIG. 3A, larger implementations of output logic unit 2030 may be implemented using the embodiment shown here as a basic building block.

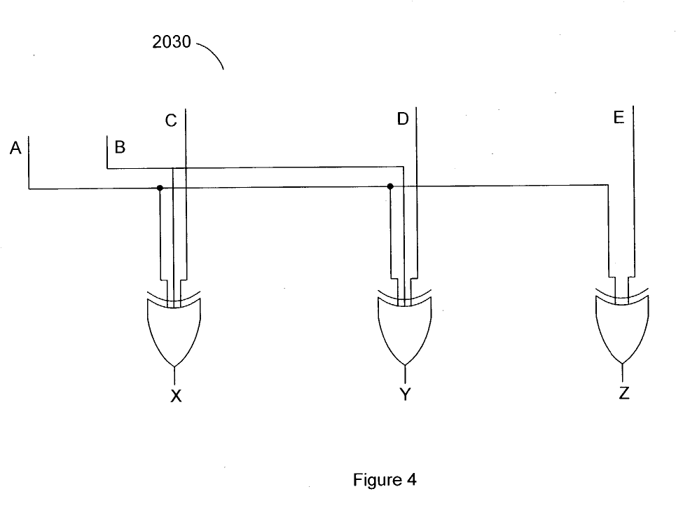

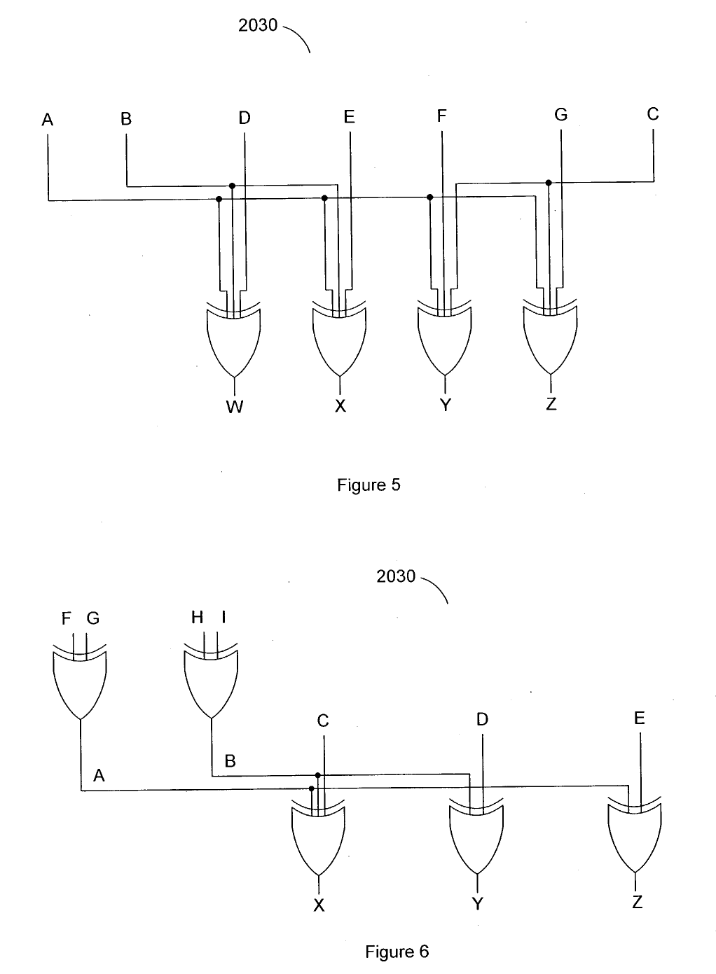

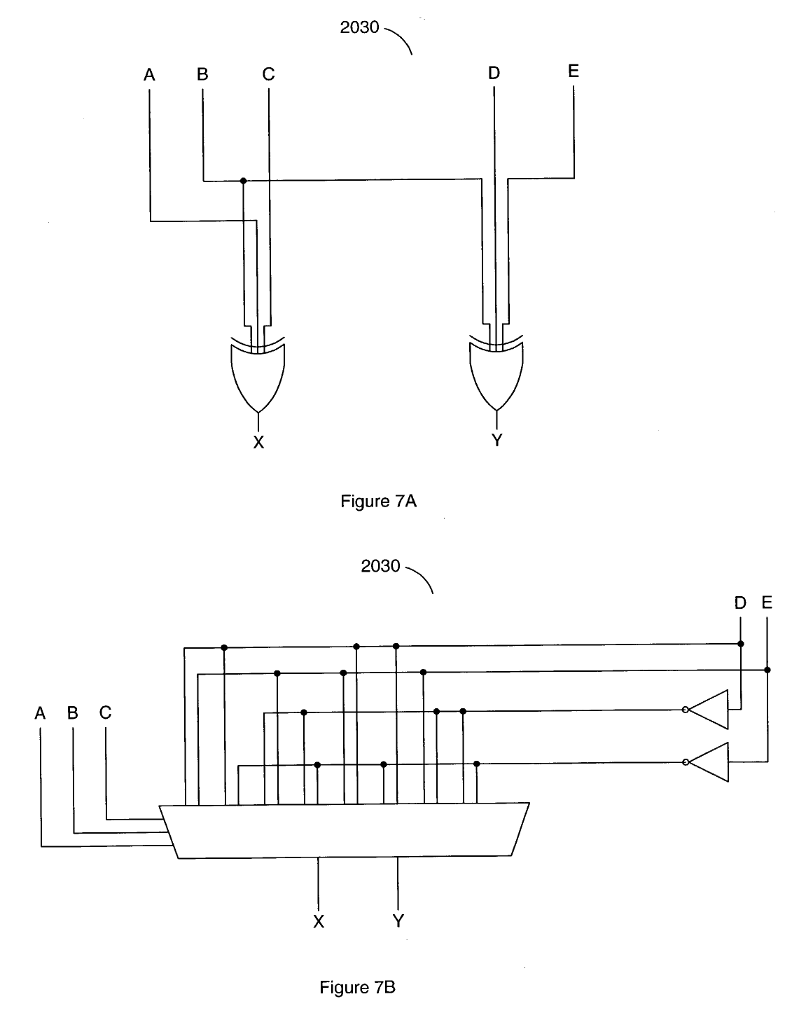

Moving now to FIG. 4, a diagram of another embodiment of a logic unit for obscuring the internal state of a random number generator is shown. In this particular embodiment, output logic unit 2030 is configured to receive 5 input bits and produce 3 output bits (m=3 and n=0.67). The randomly generated bits A, B, C, D, and E may each be input to one or more of the XOR gates (or XOR functions) in this embodiment and produce outputs X, Y, and Z. FIG. 5 is another embodiment of an output logic unit 2030, were 4 output bits (m=4) are produced based on 7 input bits (and thus n=0.75) input into an XOR function. FIG. 6 is a block diagram of another embodiment of output logic unit 2030, where 3 output bits (m=3) are produced by 8 input bits (and thus n=1.67) input into an XOR function. FIG. 7A is a diagram of another embodiment of output logic unit 2030, wherein 5 bits (m=5) input into an XOR function produce 2 output bits (and thus n=1.5).

FIG. 7B is a block diagram of another embodiment of output logic unit 2030, where the number of inputs and outputs is the same as shown in FIG. 7A, but the function performed is different. The data bits D and E may product output X and Y in eight different ways in this embodiment, as shown in table 2, where the symbol ‘˜’ indicates negation.

TABLE 2

| | X | Y |
|---|---|---|
| 1 | D | E |
| 2 | D | ˜E |
| 3 | ˜D | E |
| 4 | ˜D | ˜E |
| 5 | E | D |
| 6 | ˜E | D |
| 7 | E | ˜D |
| 8 | ˜E | ˜D |

The protection bits A, B, and C are used to select the row of Table 2 to be the output bits X and Y.

In this example, 3 of the 5 input bits generated by a bit generation unit are input into the select inputs of the multiplexer. The two remaining bits are input as pairs to the multiplexer inputs. The select input may select one of the pairs to propagate through to the XY output of the multiplexer. Other embodiments implementing multiplexers in the manner shown in FIG. 7B wherein in different outputs are produces based on a given set of inputs are possible and contemplated.

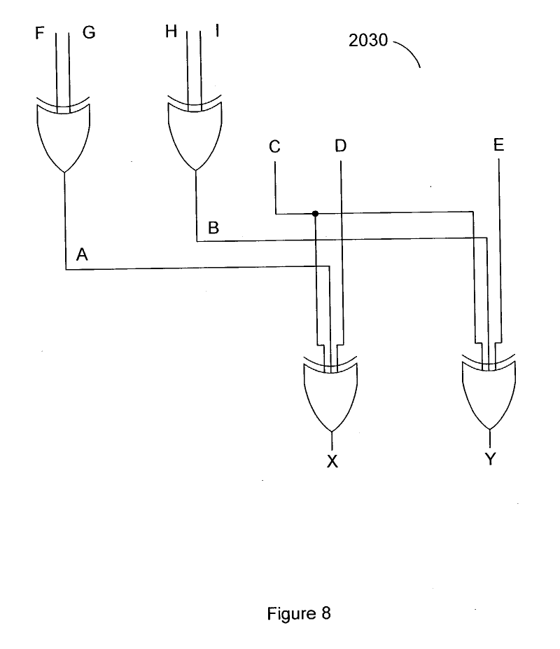

FIG. 8 is a diagram of another embodiment of output logic unit 2030. In this particular embodiment, 7 input bits produce 2 output bits (m=2, n=2.5) with two levels of XOR logic.

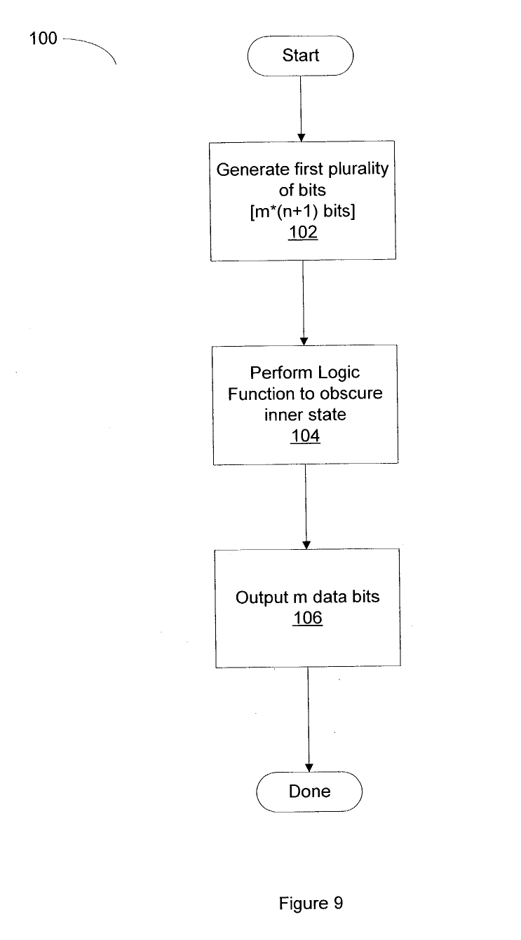

FIG. 9 is a flow diagram for one embodiment of obscuring the internal state of a random number generator. In the embodiment shown, method 100 begins with the generation of a first plurality of bits (102). The first plurality of bits may be generated by random number generator circuitry. Such random number generation circuitry may include continuous random number generators, pseudorandom number generators, Heisenberg random number generators, and so forth. The bit generation circuitry may produce a total of m*(n+1) bits, wherein m is the final number of output bits of the random number generator (after performing an logic function to obscure its internal state), and n is the ratio of protection bits to output bits. The protection bits are extra bits generated by the random number generator circuitry which aid in obscuring its internal state when the logic function is performed.

The bits generated in 102 may be provided as inputs to a logic unit (or logic function) which may obscure the inner state of the random number generator (104). The logic function performed may be one of any of the logic functions illustrated above or may be another logic function not specifically shown here. The logic functions shown above may also be used as building blocks to create obscuring logic functions for larger implementations of a random number generator. Performance of the logic function may result in a second plurality of bits being produced, wherein the number of bits in the second plurality may be less than the number of bits in the first plurality (the second plurality of bits typically includes m bits, while the first plurality includes m*(n+1) bits in this embodiments; other embodiments are possible and contemplated). Once the second plurality of m bits has been produced, it may be provided as an output by the random number generator (106).

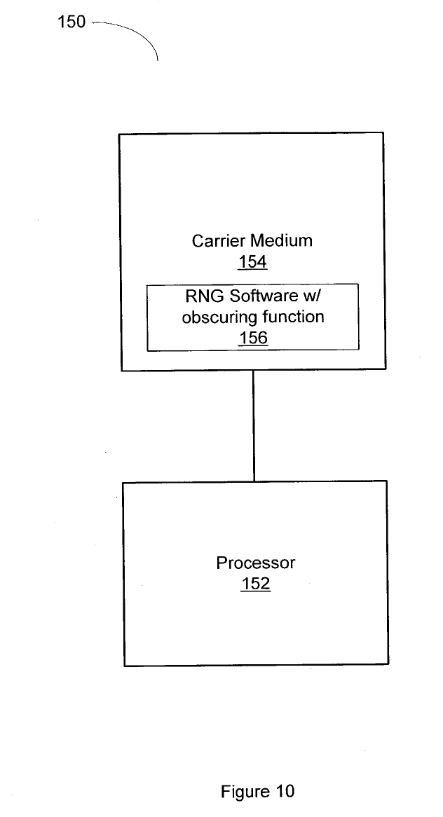

FIG. 10 is a block diagram of a computer system including a carrier medium configured to store instructions for implementing a software-based random number generator with an obscuring function. In the embodiment shown, computer system 150 may include processor 152 which may be coupled to carrier medium 154. Carrier medium 154 may be any type of carrier medium, such as random access memory, hard disk storage, flash memory, and so on.

Random number generation software 156 may be stored in carrier medium 154. Processor 152 may execute instructions comprised in random number generation (RNG) software 156 in order to perform random number generation. RNG software 156 may include an obscuring function designed to obscure the internal state of operation for a bit generation function that may be performed during its execution. The obscuring function may be based upon building blocks such as those shown above in FIGS. 3A-8, and may be based upon XOR functions and/or multiplexer functions. Other logic functions for implementing an obscuring function are also possible and contemplated.

As with random number generator 2020 shown in FIG. 2, execution of the instructions for RNG software 156 may result in the generation of a plurality of protection bits prior to performing the obscuring function. In one embodiment, a total of m*(n +1) bits may be generated by a random bit generation function, while a total of m bits may provided as the resulting output from execution of the RNG software instructions (where n is the ratio of protection bits to data bits as in the previously described embodiments).

While several of the embodiments illustrated herein use XOR gates to provide the logic function, other embodiments are possible and contemplated wherein XNOR gates may be used. Embodiments using other types of logic gates and/or other types of logic functions are also possible and contemplated.

While the present invention has been described with reference to particular embodiments, it will be understood that the embodiments are illustrative and that the invention scope is not so limited. Any variations, modifications, additions, and improvements to the embodiments described are possible. These variations, modifications, additions, and improvements may fall within the scope of the inventions as detailed within the following claims.

What is claimed is:

1. A method for obscuring the internal state of a random number generator, the method comprising:
randomly generating a first plurality of bits, wherein the first plurality of bits includes at least one protection bit and one or more generated data bits;
performing a logic function on the first plurality of bits; and
outputting a second plurality of bits, wherein the second plurality of bits is generated by performing the logic function on the first plurality of bits.

2. The method as recited in claim 1, wherein the one or more generated data bits includes m bits, and wherein the first plurality of bits includes m*(n+1) bits, wherein n is a ratio of a number of protection bits to a number of generated data bits.

3. The method as recited in claim 2, wherein the second plurality of bits includes m bits.

4. The method as recited in claim 2, wherein the logic function is an exclusive OR (XOR) function.

5. The method as recited in claim 4, wherein the XOR function is performed by a plurality of XOR gates, wherein the plurality of XOR gates includes at least m gates.

6. The method as recited in claim 4, wherein the XOR function is performed by a processor executing computer instructions.

7. The method as recited in claim 2, wherein the logic function is a multiplexer function, the multiplexer function including a plurality of inputs and at least one select input.

8. The method as recited in claim 7, wherein the multiplexer function is implemented in hardware.

9. The method as recited in claim 7, wherein the multiplexer function is implemented in software.

10. The method as recited in claim 1, wherein said outputting is performed synchronous to a clock signal, and wherein said outputting occurs at least once during each cycle of the clock signal.

11. The method as recited in claim 1, wherein a number of bits of the second plurality is less than a number of bits of the first plurality.

12. A random number generator comprising:
a bit generation unit, wherein the bit generation unit is configured to randomly generate a first plurality of bits, wherein the first plurality of bits includes at least one protection bit and at least one generated data bit; and
a logic unit, wherein the logic unit is configured to perform a logic function on the first plurality of bits and output a second plurality of bits, wherein the second plurality of bits is generated by performing the logic function on the first plurality of bits.

13. The random number generator as recited in claim 12, wherein the one or more generated data bits includes m bits, and wherein the first plurality of bits includes m*(n+1) bits, wherein n is a ratio of a number of protection bits to a number of generated data bits.

14. The random number generator as recited in claim 13, wherein the second plurality of bits includes m bits.

15. The random number generator as recited in claim 13, wherein the logic function is an exclusive OR (XOR) function.

16. The random number generator as recited in claim 15, wherein the XOR function is performed by a plurality of XOR gates, wherein the plurality of XOR gates includes at least m gates.

17. The random number generator as recited in claim 15, wherein the XOR function is performed by a processor executing computer instructions.

18. The random number generator as recited in claim 13, wherein the logic function is a multiplexer function, the multiplexer function including a plurality of inputs and at least one select input.

19. The random number generator as recited in claim 18, wherein the multiplexer function is implemented in hardware.

20. The random number generator as recited in claim 18, wherein the multiplexer function is implemented in software.

21. The random number generator as recited in claim 12, wherein the logic unit is configured to output the second plurality of bits synchronous to a clock signal and wherein outputting occurs at least once during each cycle of the clock signal.

22. The random number generator as recited in claim 13, wherein a number of bits of the second plurality is less than a number of bits of the first plurality.

23. A computer system comprising:
a processor;
a carrier medium coupled to the processor, wherein the carrier medium is configured to store instructions that, when executed by the processor, cause the processor to:
randomly generate a first plurality of bits, wherein the first plurality of bits includes at least one protection bit and one or more generated data bits;
perform a logic function on the first plurality of bits; and
output a second plurality of bits, wherein the second plurality of bits is generated by performing the logic function on the first plurality of bits.

24. The computer system as recited in claim 23, wherein the one or more generated data bits includes m bits, and wherein the first plurality of bits includes m*(n+1) bits, wherein n is a ratio of a number of protection bits to a number of generated data bits.

25. The computer system as recited in claim 24, wherein the second plurality of bits includes m bits.

26. The computer system as recited in claim 24, wherein the logic function is an exclusive OR (XOR) function.

27. The computer system as recited in claim 24, wherein the logic function is a multiplexer function.

28. The computer system as recited in claim 24, wherein the processor is configured to output the second plurality of bits synchronous to a clock signal, and wherein outputting occurs at least once during each cycle of the clock signal.

29. The computer system as recited in claim 24, wherein a number of bits of the second plurality is less than a number of bits of the first plurality.
